(19) United States
(12) Patent Application Publication
(10) Pub. No.: US 2006/0105312 A1
(43) Pub. Date: May 18, 2006

(54) Systems and methods for creating and providing educational materials

(76) Inventors: Desiree Leigh McClimon, Phoenixville, PA (US); Amy Maureen Maguire, Winston-Salem, NC (US)

Correspondence Address: Charles W. Calkins, Esq.;Kilpatrick Stockton LLP, 1001 West Fourth Street, Winston-Salem, NC, 27101, US

(21) Appl. No.: 10/990,759

(22) Filed: Nov. 17, 2004

(51) Int. Cl. G09B 3/00

(52) U.S. Cl. 434/350

(57) ABSTRACT

The present invention provides systems, methods and computer readable media for generating, providing and distributing educational materials. In an embodiment, an educational material may be customized to provide an enhanced learning experience using information relating to the individual being educated. The present invention also provides educational materials comprising a customized portion.

### FIELD OF THE INVENTION

The present invention relates to systems, methods and computer readable media for providing educational materials. An embodiment of the present invention is advantageous for providing educational materials for special needs children or adults, such as developmentally disabled, or developmentally delayed children or adults.

### BACKGROUND

Many educators, therapists, administrators, and caregivers purchase, collect, modify, and create materials to meet the needs of individual student's abilities. However, there is no system with a comprehensive database of materials that can align to individual student's skill levels based on developmental ages in such categories as academic, behavioral, daily living/adaptive, motor, communication, social, and cognitive allowing a customized education plan to be developed for each student.

In order to manage students' educational development, computer systems have been implemented to provide student specific information to educators, therapists, administrators, caregivers, and others. While these systems have proven to be useful for various purposes, they have primarily been clerical in nature and used for documentation, rather than educational tools. Accordingly, tools are necessary for processing student development information, from educators, therapists, administrators, and caregivers, and then providing comprehensive education plans and materials to the user, educators, therapists, administrators, and caregivers which are customized for the individual student on an ongoing basis.

### SUMMARY OF THE INVENTION

The present invention provides systems, methods and computer readable media for creating, providing and/or distributing educational materials. The present invention also provides user customized educational materials. In an embodiment, the present invention provides educational materials which increase a child's learning and development through customized materials which closely target each individual child's needs.

Educational materials include, but are not limited to, audio materials; visual materials; audio/visual materials; written materials and the like. Educational materials may comprise materials for teaching a skill; teaching a procedure; teaching a task or tasks; providing a curriculum; and/or monitoring development of a skill, procedure, task, or curriculum. Educational materials may further comprise the types of materials utilized in educational institutions.

An embodiment of the present invention is particularly advantageous for providing educational materials for Individuals with a developmental disability. The terminology developmental disability is generally used to refer to a disability normally acquired prior to the age of twenty-two (22) years that affects cognitive, social, communication, and adaptive skills and behaviors. Some common developmental disabilities include: Mental Retardation, Autism, Asperger's Syndrome, Down's Syndrome, Cerebral Palsy, and Spina Bifida. Individuals suffering from a developmental disability may be referred to as developmentally delayed. Children or adults who do not meet the criteria for a developmental disability, or otherwise normal children, may be developmentally delayed in one or more areas. For example, an otherwise normally developing child may delayed in a single area, for example imaginative play.

Individuals on the Autism Spectrum are those people who have a diagnosis of Autism, Asperger's Syndrome, and/or Pervasive Developmental Disorder. Individuals with diagnoses of this spectrum suffer from impairments in the areas of communication, social interactions, and restricted/repetitive behaviors. It has been hypothesized that individuals on the Autism Spectrum have not developed Theory of Mind. Theory of Mind is simply the understanding and knowledge that others have thoughts and feelings different from their own. A proposed reason this is so difficult for these individuals, is that they are unable to effectively read facial cues. Finally, individuals with Autism Spectrum disorders and Developmental Disabilities may have significant problems in developing peer interactions and friendships.

In an embodiment, a system of the present invention comprises at least one template, generally a plurality of templates. Each template comprises information to be conveyed to a recipient of the training/education. The information may relate to one or more of the following: a skill; a task; an activity; a social situation; an environmental condition; or the like. An educational material of the present invention comprises a template, or a plurality of templates.

In an embodiment, a template comprises at least one information block, generally a plurality of information blocks. Information blocks may be substituted in or out of a template, or exchanged among templates to provide customized educational materials. In an embodiment of the present invention, an information block may be customized based on one or more of the following factors:

A physical trait of an individual;

A detail of an individual's environment;

A developmental level of an individual;

A skill level of an individual;

A detail of an individual's life;

A detail of an individual's community; and/or

A pattern of tasks.

The individual may represent the student or intended recipient of the training imparted by the educational materials. The factors may be obtained through interaction with the provider of the educational materials to the student, for example a teacher, parent, counselor or person in a similar role with respect to the recipient of the training. More details relating to the these factors, templates, information blocks and the customization of educational materials are set forth below.

A system of the present invention may be advantageously implemented over a computer network. In an embodiment, a system of the present invention comprises a server accessible over a network; and a client device capable of accessing the server over the network. The server may comprise, or communicate with, a database. The database may comprise template data relating to the templates; data relating to the information blocks; data relating to the factors; and related data. The client device may comprise a user interface, for example a graphical user interface; and an input apparatus to allow the inputting of data, such as the factors set forth above and/or similar data utilized to generate information blocks. In an embodiment, the server and the client device may be networked via the world wide web.

More details relating to systems of the present invention and computer hardware and software for implementing a system of the present invention are set forth in the following section.

The present invention also provides methods for creating, providing and/or distributing education material. In an embodiment, the present invention provides a method for creating an educational material comprising providing a template, the template comprising at least a portion capable of being populated; and populating the portion of the template capable of being populated to create an educational material. The information used in populating the template may comprise information collected from a user, such as the factors set forth above. Thus, in an embodiment, a method of the present invention for creating an educational material may further comprise collecting information from a user relating to the recipient of the education/training and populating the template with at least a portion of the information. The individual may be the intended recipient of the education/training (e.g. the student), a caregiver for the intended recipient of the education/training; the trainer/instructor (e.g. the teacher); or someone with a similar relationship to the intended recipient of the education/training. The educational materials may comprise the educational materials and types of educational materials set forth above.

In an embodiment the present invention provides a method for providing an educational material to a user, the method comprising receiving input from the user; creating an educational material responsive to said input; and providing the educational material to the user. The input may comprise information relating to the type of educational material desired by the user. The input may also, or further, comprise information relating to an intended recipient of the education/training provided by the educational material.

In an embodiment, the present invention provides a method for distributing an educational material to a user, the method comprising receiving input from the user relating to the desire for an educational material and distributing the educational material to the user.

The methods of providing an educational material, and/or distributing an educational material, may further comprise the steps set forth in a method for creating an educational material.

Methods of the present invention may be advantageously implemented over a network, such as the internet/world wide web, using computer hardware and software.

In another aspect, the present invention provides computer readable media. In an embodiment, computer readable media of the present invention comprise program code for implementing steps of a method of the present invention.

In a further aspect, the present invention provides educational materials. In an embodiment, an educational material of the present invention comprises content relating to a recipient of the education/training. The content may comprise one or more of the factors described above with reference to a system of the present invention. An educational material of the present invention may be advantageously produced using a method of the present invention, however the educational materials of the present invention are not limited to educational materials created by a method of the present invention, but rather include educational materials produced by different methods.

Embodiments of the present invention are advantageous for use in the education/training of children and/or adults and may be particularly advantageous for use in the education/training of developmentally delayed children and/or adults. In embodiments, the present invention allows for the creation of educational materials that place the recipient of the education/training within the educational material, and/or simulate the environment of the recipient of the education/training material. As such the recipient of the education/training material can “see” themselves performing the tasks/skills to be acquired as part of the education/training.

A further advantage of the present invention is that embodiments of the present invention provide for collecting and processing student specific information and generating customized, comprehensive education plans, activities, and materials for individual students based on such input and to increase the learning and development of each student while reducing costs and increasing efficiency to the education system.

The foregoing introduction is provided to introduce the reader to the general subject matter of the application. The invention described herein is not limited, and should not be construed as limited to such subject matter. Additional features and advantages of the present invention and embodiments of the present invention are set forth in the following paragraphs.

### BRIEF DESCRIPTION OF THE DRAWINGS

FIG. 1 is a diagram illustrating an example of an environment in which an embodiment of the present invention may operate.

FIG. 2 is a block diagram providing the steps of a method according to one embodiment of the present invention.

FIG. 3 is a block diagram providing the steps of determining relevant information according to one embodiment of the present invention.

FIG. 4 is a block diagram providing the steps of delivering the customized document to the user according to one embodiment of the present invention.

FIG. 5 is a visual representation of the method followed in the selection of certain information blocks for certain spaces in a template according to one embodiment of the present invention.

FIG. 6 is a visual representation of the template after the information blocks have been selected and inserted into the template according to one embodiment of the present invention.

### DETAILED DESCRIPTION

As set forth above, the present invention provides systems, methods and computer readable media for creating; providing and/or distributing educational materials.

In an embodiment the present invention provides a method for providing educational materials with customized information, comprising the steps of: providing a template for educational materials containing at least one portion of customizable information; and populating the template with at least one of a plurality of information blocks. The method may further comprise the steps of: determining which at least one information block is desired by a user; and delivering the template containing the desired at least one information block to the user.

In the description contained herein reference is made to a user. A user may comprise an educator, parent, instructor, counselor, sibling or like individual who will be using educational materials to provide skills or life training to an individual. A user may also comprise an individual who is to received skills or life training from the educational materials discussed herein. As will be realized from the following description, information relating to either type of user, teacher or recipient, may be stored and retained in information blocks.

In an embodiment the template for a written work and the plurality of information blocks are stored on at least one database server. The written work and the plurality of information blocks may be stored on the same database server or on separate database servers.

A method of the present invention may further comprise the step of collecting user profile information from the user. The information blocks may be associated with user profile factors.

In an embodiment of a method of the present invention determining which at least one information block is desired by a user comprises the steps of: reading the user profile information collected from the user; comparing the user profile information to the user profile factors associated with each of the plurality of information blocks; selecting information blocks associated with user profile factors that are matches of the collected user profile information; and if no user profile factors are matches of the collected user profile information, selecting at least one information block.

In an embodiment, delivering the template and the desired at least one information block to the user comprises the steps of: retrieving the template and the desired at least one information block from the at least one database server; transmitting the template and the desired at least one information block over a network; and receiving the template and the desired at least one information block at a display device. The display device may comprise a client device and/or a printer. The network may comprise the database server and a personal computer, and may further comprise, or alternatively comprise a web server and the Internet. In an embodiment the template and the desired at least one information block are transmitted from the database server to the web server and from the web server to the personal computer via the Internet.

A method of the present invention may further comprise storing user profile information in a storage medium. The user profile information comprises the user profile information collected from the user and may further comprise information identifying products previously purchased by the user. The user profile information or portions thereof in the storage medium may be updated periodically without any new input from the user. In an embodiment, a method of the present invention may comprise the step of contacting the user at various time intervals to request updated user profile information. A user may be offered products for sale based on the profile information.

A system of the present invention comprises computer hardware, software and/or firmware sufficient to perform a method of the present invention.

Computer readable media of the present invention comprises programmable computer code for implementing steps of a method of the present invention.

The present invention also provides educational materials. In an embodiment, an educational material of the present invention comprises a template. The template comprises at least one information block including information received from an individual. The template may comprise an audio-visual template, a written template, an illustrated template, or something similar.

An educational material of the present invention may be substantially complete, or may be in a form that allows for further customization by a user. For example, an educational material of the present invention may comprise line drawings that allow for illustration by a user.

The appended Figures provide schematic overviews of some embodiments of methods and systems of the present invention. It will be understood that each element of the illustrations, and combinations of elements in the illustrations, in the Figures, can be implemented by general and/or special purpose hardware-based systems that perform the specified functions or tasks, or by combinations of general and/or special purpose hardware and computer instructions (or computer program code). Some embodiments of the present invention relate to a computer-readable medium, having computer-readable instructions or computer program code for performing the specified functions, tasks, or steps.

This computer program code can be provided to a processor to produce a machine, such that the program code that executes on the processor creates means for implementing the functions and tasks specified in the illustrations. The computer program code can be executed by a processor to cause a series of operational steps to be performed by the processor to produce a computer implemented process such that the code which executes on the processor provides steps for implementing the functions and tasks specified in the illustrations. Accordingly, the description contained herein and the Figures support combinations of means for performing the specified functions, combinations of steps for performing the specified functions, and computer program code for performing the specified functions.

It will be understood that systems, methods and computer program products according to the present invention can be advantageously implemented as a stored computer software program that executes on a data processing system. Any such system can be used. In some embodiments, a legacy data processing system, such as an IBM Model S/390 can be used. In some embodiments, midrange or personal systems, or a network of legacy, midrange and personal systems, are used.

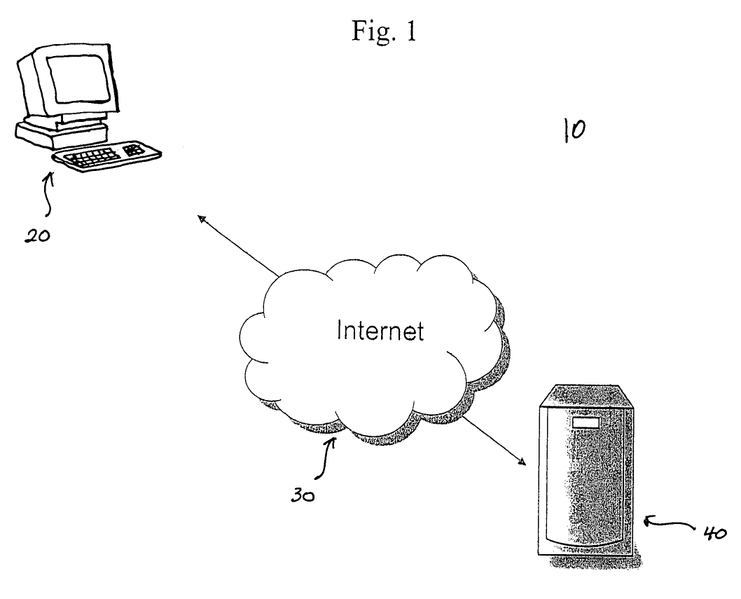

Referring now to FIG. 1, an embodiment of the present invention involves delivering customized information to a user over a computer network 10. The system shown comprises a client device 20 in communication with a server device 40 over a network 30. The network 30 shown comprises the Internet. In other embodiments, other networks, wired and wireless, such as an intranet, local area network, wide area network, or broadcast network may be used. Moreover, methods according to the present invention may operate within a single client or server device.

A client device may comprise a computer-readable medium, such as a random access memory (RAM) in communication with a processor. The processor executes computer-executable program instructions stored in the memory. Such processors may comprise a microprocessor, an ASIC, or state machines. Such processors comprise, or may be in communication with, media, for example computer-readable media, which stores instructions that, when executed by the processor, cause the processor to perform operations, such as those described herein.

Embodiments of computer-readable media include, but are not limited to, electronic, optical, magnetic, or other storage or transmission devices capable of providing a processor with computer-readable instructions. Other examples of suitable media include, but are not limited to, a floppy disk, CD-ROM, DVD, magnetic disk, memory chip, ROM, RAM, an ASIC, a configured processor, optical media, magnetic tape or other magnetic media, or any other suitable medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#; Visual Basic, Java, Python, Perl, and JavaScript.

Client devices may also comprise a number of external or internal devices such as a mouse, a CD-ROM, DVD, a keyboard, a display, or other input or output devices. Examples of client devices are personal computers, personal digital assistants, cellular phones, mobile phones, smart phones, pagers, digital tablets, laptop computers, Internet appliances, and other processor-based devices. In general, a client device may be any type of suitable processor-based platform that is connectable to a network and that interacts with one or more application programs. Client devices may operate on any operating system, such as Microsoft® Windows® or Linux. The client device shown includes, for example, personal computers executing a browser application program such as Microsoft Corporation's Internet Explorer™, Netscape Communication Corporation's Netscape Navigator1υ, and Apple Computer, Inc.'s Safari™.

Similar to the client devices the server comprises a processor coupled to a computer-readable memory. The server may be in communication with a data store. The server may comprise a single computer system and/or may be implemented as a network of computer processors. Examples of servers include mainframe computers, networked computers, a processor-based device, and similar types of systems and devices. Client processor and the server processor can be any of a number of computer processors, such as processors from Intel Corporation of Santa Clara, Calif. and Motorola Corporation of Schaumburg, Ill.

It should be noted that this invention may comprise systems having different architecture. The system shown in FIG. 1 is merely an example of a suitable system, and is used to help explain the methods illustrated in the remaining Figures.

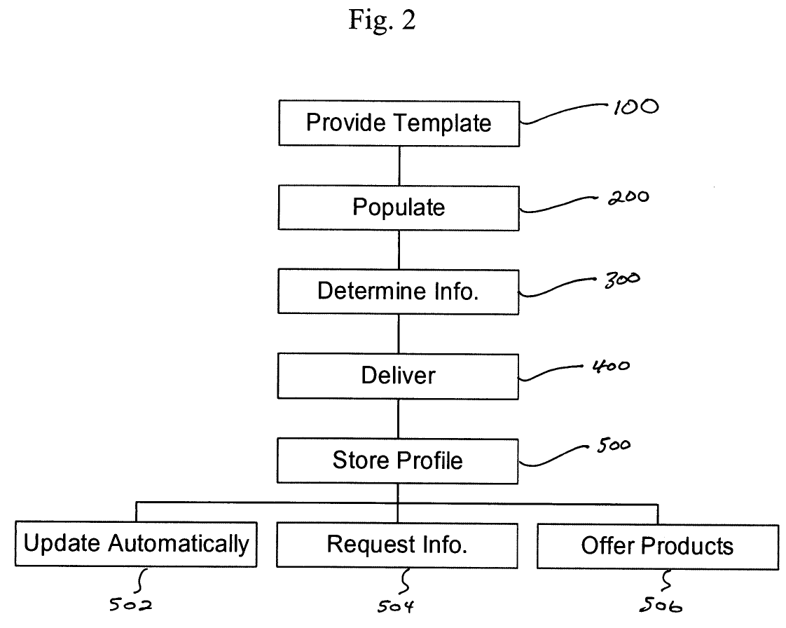

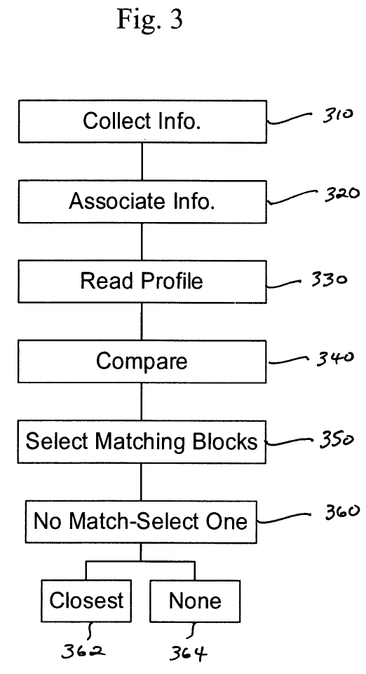

Referring now to FIG. 2, an embodiment of the present invention comprises the steps of providing 100 a template for educational materials, and populating 200 the template with at least one of a plurality of information blocks. In one embodiment, the method further comprises the steps of determining 300 which information blocks are desired by a particular user, and delivering 400 the template and at least one desired information block to the user. Referring now to FIG. 3, the method may further comprise the steps of collecting 310 user profile information from the user, and associating 320 each of the plurality of information blocks with user profile factors. The user profile information can be collected 310 from the user by asking questions of the user and recording the responses. The user profile information also can be collected 310 by recording the selections that the user makes on a website. The user profile factors can be associated 320 with particular information blocks before or after the information blocks are stored in the database server. The user profile factors indicate which information blocks contain information relating to certain elements of a user profile. In one embodiment, the step of determining 300 which at least one information block is desired by a user comprises the steps of reading 330 the user profile information collected 310 from the user; comparing 340 the user profile information to the user profile factors associated 320 with each of the plurality of information blocks; selecting 350 all information blocks associated 320 with user profile factors that are exact matches of the collected 310 user profile information; and if no user profile factors are exact matches of the collected 310 user profile information, selecting 360 at least one information block.

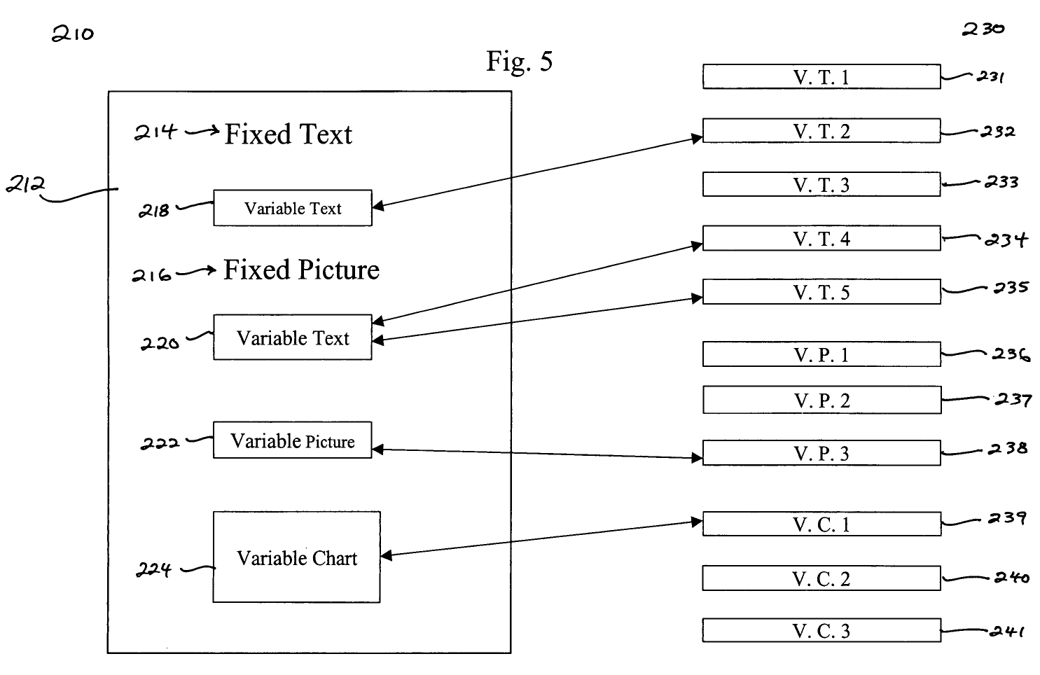

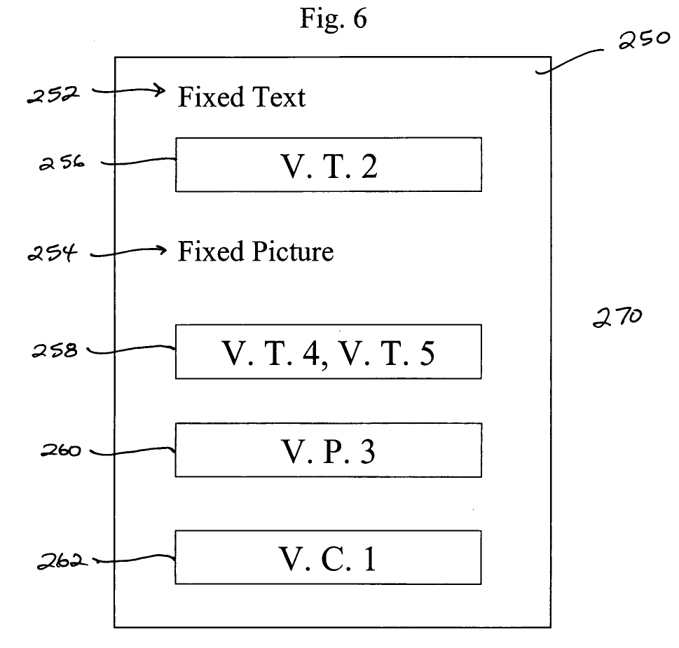

FIG. 5 provides an example of a customized document 210 comprising a template 212. The template 212 may contain some fixed text 214 and some fixed picture 216. The template 212 may also contain spaces 218, 220, 222, 224 into which can be inserted variable text (218, 220), variable pictures (222), and variable charts (224), or graphics, audio files, video files, and any other communication medium. The template 212 for the educational materials relates to a specific lesson or group of lessons. For example, one template 212 of educational materials could relate to the process of a child managing her feelings of anger. The spaces 218, 220, 222, 224 of the template 212 are populated by information blocks from the group 230 of information blocks made available for that template 212. In FIG. 5, there are information blocks for variable text 231-235, for variable pictures 236-238, and for variable charts 239-241. Referring now to FIGS. 5 and 6, the space 218 for variable text is populated by an information block 232 for variable text, creating a populated space 256. The space 220 for variable text is populated by two information blocks 234, 235 for variable text, creating a populated space 258. There need not be a one-to-one relationship between spaces and information blocks. The space 222 for variable picture is populated by an information block 238 for variable picture, creating a populated space 260. Finally, the space 224 for variable chart is populated by an information block 239 for variable chart, creating a populated space 262. In the example shown in FIG. 6, the template 250 containing fixed text 252, fixed picture 254, and populated spaces 256, 258, 260, 262 constitutes a completed customized document 270. A customized document may comprise any single information block or any combination of fixed items and variable items, in any communication medium.

It is possible for one information block to be available in more than one template, or, as shown in FIG. 5, in more than one portion of the same template. Referring to the above example regarding a template for a child managing her feelings of anger, a process for managing anger in five-year-old children could include a step of thinking before acting. An information block could contain a description of the step of thinking before acting, and that information block could be inserted into the template for managing anger in five-year-old children. The step of thinking before acting also could be used in a template for other ages of children. Therefore, it is sometimes advantageous to have the same information block available to multiple templates. In another example, the “thinking before acting” step could be the first step of managing anger, or it could be the second or third step. It is possible that there is an information block for each step of the process of managing anger. In that situation, it is advantageous to have the same information block available at multiple locations within the template, i.e. at the first step, the second step and the third step in the process for managing anger. To prevent multiple uses of the same information block when multiple uses are not desired, either the template or the information block could contain tagging information such as metadata that would prevent the insertion of the information block into the template more than once.

Following the above example regarding anger management, one information block may contain information regarding anger management techniques for children ages 3-4, while another information block may contain information regarding anger management techniques for children ages 3-5. The age ranges constitute user profile factors, the labels on the information blocks that reveal what kind of information is contained in each information block. The age ranges would be stored as user profile factors and associated 320 with the appropriate information blocks. Then user profile information would be collected 310. If the user specified an interest in anger management in three-year-old children, the user profile information, namely an interest in three-year-old children, would be compared 340 with the user profile factors of the two available information blocks containing information about children ages 3-4 and 3-5, respectively. Then both information blocks would be selected 350 and inserted into the template because both information blocks have user profile factors that match the supplied user profile information.

In another example, if the user provides user profile information that indicates an interest in anger management techniques for five-year-old children, then that user profile information would be compared 340 with the user profile factors, information blocks containing information about children ages 3-4 and 3-5, respectively. In that scenario, only the second information block would be selected 350 and inserted into the template, because only the user profile factor on the second information block matched the user profile information.

In another example, the user enters a user profile information that indicates an interest in anger management techniques for six-year-old children. If no information blocks contain information regarding six-year-old children, then there will be no user profile factors to indicate that an information block contains information about six-year-old children. In that case, the user profile information would not match 360 any user profile factors. Then the closest user profile factor could be selected 362 and its information block included in the template. In this example, the anger management techniques for children ages 3-5 would be closer to a six-year-old child than the techniques for children ages 3-4, so that information block could be inserted into the template. In the alternative, no information blocks could be selected 364 and inserted into the template, and instead the template could include a notice that no information blocks matched the desired information.

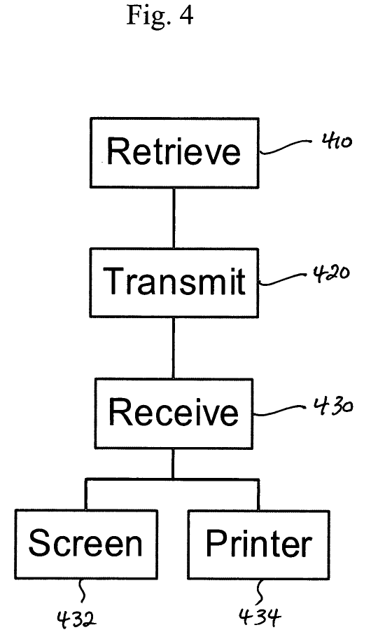

Referring now to FIGS. 2 and 4, when the appropriate information blocks about anger management have been selected 350 and inserted into the template, the template and information blocks could be retrieved 410 from the database and transmitted 420 over the network and received 430 at a display device. The display device could be a client device display screen 432, a printer 434, or any other display device. The template and information blocks could arrive as one data file, as a plurality of data files, as streaming data, or in any other manner.

Referring again to FIG. 2, another embodiment of the present invention further comprises the step of storing 500 the user profile information collected from the user in a storage medium. The storage medium could be a computer hard drive, a database server, or any other storage medium. The stored user profile information could be updated 502 without further input from the user. For example, if a user indicates an interest in anger management techniques for three-year-old children, after the passage of a year, that information could be updated 502 to relate to four-year-old children, without any new input from the user. The user profile information could also remain unaltered, in the event that the user works with a certain age-group, for example. The stored user profile information also could be used to generate requests 504 for new user profile information. For example, if a user indicates an interest in techniques for three-year-old children, after the passage of one year, requests 504 for updated user profile information could be generated to determine whether the user would now be interested in techniques for four-year-old children.

In another embodiment, the stored user profile information could be used to generate offers for sale 506 of related products. The user profile information may include a record of products already purchased or researched by the user. For example, the user profile information could be reviewed after the passage of some period of time to see what the user has previously indicated as an interest or to see what products the user has already purchased. Offers for sale 506 could then be generated for products relating to the prior interests or prior purchases of the user.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention. Other embodiments are possible and can be more practical for different applications.

What is claimed is:

1. A method for providing educational materials comprising the steps of:
providing a template for educational materials containing at least one portion capable of being populated; and
populating the template with information.

2. The method of claim 1, further comprising the steps of:
determining at least one piece of information desired by a user; and populating the template with the information.

3. The method of claim 2 further comprising determining a plurality of pieces of information desired by a user and populating the template with the plurality of information.

4. The method of claim 1 wherein the template comprises a written work.

5. The method of claim 1 wherein the template comprises an audio-visual work.

6. A system for providing educational materials comprising: a client device; a server; a network comprising the client device and the server; a template for an educational material resident on the server, the template containing at least one portion capable of being populated; wherein the server is capable of receiving input for populating the template from the client device via the network.

7. The system of claim 6 wherein the network comprises the world wide web.

8. Computer readable media for providing an educational material comprising:
program code for providing a template for educational materials containing at least one portion capable of being populated; and
program code for populating the template with information.

9. The computer readable media of claim 8 further comprising: program code for determining at least one piece of information desired by a user; and program code for populating the template with the information.

10. An educational material comprising: a template populated with information relating to an individual being educated.
